(19) United States
(12) Patent Application Publication
(10) Pub. No.: US 2021/0291278 A1
(43) Pub. Date: Sep. 23, 2021

(54) CUTTING INSERT AND TOOL FOR MACHINING A WORKPIECE

(71) Applicant: Hartmetall-Werkzeugfabrik Paul Horn GmbH, Tuebingen (DE)

(72) Inventor: Hans Schaefer, Gomaringen (DE)

(21) Appl. No.: 17/340,714

(22) Filed: Jun. 7, 2021

Related U.S. Application Data
(63) Continuation of application No. PCT/EP2020/055210, filed on Feb. 27, 2020.

(30) Foreign Application Priority Data
Mar. 7, 2019 (DE) 10 2019 105 752.3
Mar. 7, 2019 (DE) 20 2019 101 271.4

(51) Int. Cl. B23B 27/00; B23B 27/14

(52) U.S. Cl. CPC B23B 27/007; B23B 27/143

(57) ABSTRACT

Cutting insert having a clamping section, a cutting head, and a cantilever arm, at a first end of which the cutting head is arranged and at a second end of which, opposite the first end, the clamping section is arranged, wherein the cantilever arm has a smaller cross-section than the clamping section, wherein the cutting head comprises at least one cutting edge and a rake face adjacent to the at least one cutting edge, an wherein the rake face comprises a relief-like surface having a chip-breaking geometry that causes chip deflection and thus chip breakage.

### CROSS REFERENCE TO RELATED APPLICATIONS

This application is a continuation of international patent application PCT/EP2020/055210, filed on Feb. 27, 2020 designating the U.S., which international patent application has been published in German language and claims priority from German patent application DE 10 2019 105 752.3 and German utility model application DE 20 2019 101 271.4, both filed on Mar. 7, 2019. The entire contents of these priority applications are incorporated herein by reference.

### BACKGROUND

This disclosure relates to a cutting insert. This disclosure further relates to a tool having a cutting insert, a tool holder comprising a cutting insert receptacle, and a fastening element for fastening the cutting insert in the cutting insert receptacle.

Cutting inserts of this generic type and associated tools have already been marketed by the applicant for several years under the name “Horn Supermini®”. Exemplary cutting inserts and tools of this type are known from DE 101 45 667 A1, DE 10 2015 104 057 A1 and DE 10 2016 105 354 A1. This tool system offers the possibility of fixing cutting inserts with differently shaped cutting heads in the tool holder, depending on the application. The tool system is suitable for grooving and hollow turning of bores as well as for axial grooving and thread turning. Due to the geometry and size of the cutting insert as well as the tool holder, the mentioned tool system is particularly suitable for machining small bores, starting from a diameter of 0.2 mm.

Such cutting inserts comprise a clamping section that can be inserted into the cutting insert receptacle in the tool holder and can be fixed to the tool holder by means of a clamping screw. In contrast to “conventional” turning tools, the cutting insert receptacle provided in the tool holder is designed as a kind of blind hole or cup-shaped recess. In the assembled state of the tool, the clamping section of the cutting insert is therefore transversely to its longitudinal direction preferably completely and along its entire circumference surrounded by the tool holder.

Another feature of such a cutting insert is its comparatively special shape. The cutting insert comprises a cantilever arm which protrudes or projects forward from the clamping section. The cutting head is arranged in the region of the front face end of the cantilever arm. The cutting head, the cantilever arm and the clamping section are integrally connected to each other. The cantilever arm, which can also be referred to as boom arm, typically forms the section with the smallest diameter. The clamping section typically forms the section of the cutting insert with the largest diameter.

Cutting inserts of this type are typically made from a bar-shaped material. The cantilever arm and the cutting head arranged thereon are ground from solid. This grinding process also produces the geometry of the cutting head including the cutting edge and the rake face. Due to this grinding process and the typically very small dimensions of the cutting head, the freedom of design of the rake face adjacent to the at least one cutting edge is, for production reasons, relatively limited.

There is still potential for improvement, particularly with regard to chip formation and chip removal properties. In particular, the occurrence of short chips and a chip removal that leads the chips away from the machining point as quickly as possible are desirable. The generation of excessively long chips has the disadvantage that the chips can get caught between the cutting head and the workpiece surface to be machined and thus scratch the workpiece surface. Furthermore, the chips may wrap around the cantilever arm of the cutting insert, which in the worst case may lead to breakage of the cutting insert or its cantilever arm.

### SUMMARY

It is an object to provide a cutting insert and a tool of the above-mentioned type, which are improved in particular with regard to the chip formation and chip removal flow properties.

According to a first aspect, a cutting insert is provided, comprising:
a clamping section having a teardrop-shaped or cylindrical cross-section;
a cutting head; and
a cantilever arm;

wherein the cutting head is arranged at a first end of the cantilever arm and the clamping section is arranged at a second end of the cantilever arm opposite the first end,

wherein the cantilever arm has a smaller cross-section than the clamping section,

wherein the cutting head comprises at least one cutting edge and a rake face adjacent to the at least one cutting edge, and

wherein the rake face comprises a relief-like surface having a chip-breaking geometry that is configured to cause chip deflection and chip breakage.

According to a second aspect, a tool for machining a workpiece is provided, comprising:
a cutting insert having a clamping section, a cutting head, and a cantilever arm,
a tool holder having at a front end a cutting insert receptacle that is configured as a cup-shaped recess in the tool holder and configured to to receive the clamping section of the cutting insert; and
a fastening element that is configured to fasten the cutting insert in the cutting insert receptacle;

wherein the cutting head is arranged at a first end of the cantilever arm and the clamping section is arranged at a second end of the cantilever arm opposite the first end,

wherein the cantilever arm has a smaller cross-section than the clamping section,

wherein the cutting head comprises at least one cutting edge and a rake face adjacent to the at least one cutting edge, and

wherein the rake face comprises a relief-like surface having a chip-breaking geometry that is configured to cause chip deflection and chip breakage.

The rake face of the cutting insert is not designed as a smooth surface, but as an uneven or relief-like surface. It comprises one or more recesses and/or one or more elevations that are introduced into the rake face. This relief-like surface forms a chipbreaking geometry that promotes chip deflection and thus chip breakage.

This has a particularly advantageous effect with regard to the generation of chips that are as short as possible. In addition, the chip-breaking geometry of the rake face enables a most favorable chip removal flow away from the machining point (the at least one cutting edge).

With cutting inserts of this type, it has not previously been possible to produce such chip-breaking geometries on or in the rake faces. The cutting head or the cutting area is comparatively small in cutting inserts of this type. In addition, as already mentioned, the cutting insert is ground out of bar-shaped material from the solid. Therefore, it was only possible to produce flat rake faces without chip-breaking geometries.

However, it has now been found that a chip-breaking geometry can also be introduced into or onto the rake face of a cutting insert of the herein presented type. The chip-breaking geometry can be introduced into the rake face preferably by pressing or laser cutting.

Pressing has the advantage that both raised structures and recessed structures can be produced. This allows a relatively large freedom of design. In addition, the manufacturing costs can be reduced compared to the complex production by grinding the cutting head from solid.

Preferably, the cutting head is pressed, wherein the chip-breaking geometry is directly introduced into the rake face during the pressing process. Subsequently, only parts of the cutting head (e.g. the at least one cutting edge) have to be reground.

Laser cutting can also be used to introduce chip-breaking geometries into the rake face of the cutting insert. Unlike pressing, however, only recessed structures can be produced by laser cutting.

In a refinement, the chip-breaking geometry comprises a raised structure. In the present context, a raised structure is understood to mean a shaped element that projects upwards relative to the remaining parts of the rake face. Accordingly, a raised structure can also be understood as an elevation.

In an alternative refinement, the chip-breaking geometry comprises a recessed structure. In this case, a recess is preferably introduced into the rake face. This recess is arranged as a local depression that is recessed relative to the remaining parts of the rake face.

In a refinement, a first portion of the chip-breaking geometry comprises a raised structure and a second portion of the chip-breaking geometry comprises a recessed structure. Thus, in this embodiment, the chip-breaking geometry comprises both raised and recessed structures. The raised and recessed structures preferably refer to their arrangement relative to the cutting plane.

In a refinement, the at least one cutting edge comprises a first and a second cutting edge lying in a common cutting plane, wherein the chip-breaking geometry is raised and/or recessed relative to said cutting plane.

The chip-breaking geometry preferably extends along the entire length of the at least one cutting edge. In the above-mentioned case of two cutting edges, the chipbreaking geometry preferably extends along the entire length of both cutting edges. The chip-breaking geometry is preferably arranged offset to the at least one cutting edge on the rake face, i.e. it is preferably not directly adjacent to the at least one cutting edge.

In a refinement, the rake face including the chip-breaking geometry is mirror-symmetrical. Preferably, the mirror symmetry exists with respect to a symmetry plane which divides the cutting head into two halves of approximately equal size.

In a refinement, the at least one cutting edge comprises a first and a second cutting edge lying in a common cutting plane and oriented at an angle 90° relative to each other. The two cutting edges are preferably straight cutting edges. The two cutting edges include an acute angle with respect to each other, such that the cutting head is approximately triangular in shape when viewed from above.

In a refinement, the first and second cutting edges are connected to each other via an arcuate edge that also lies in the cutting plane. The tip of said triangle is thus preferably rounded. The arcuate edge connecting the two main straight cutting edges (first and second cutting edges) can also be used as a cutting edge for machining the workpiece. However, it does not necessarily have to be used as a cutting edge, which is why it is referred to herein as an edge (not a cutting edge). The arcuate edge is preferably configured as a radius, which can be of different sizes depending on the application. In principle, the radius can also be very small, so that the aforementioned tip of the triangle is then substantially pointed.

In a refinement, an upper surface of the clamping section is convexly curved and a lower surface of the clamping section comprises at least three partial surfaces, namely a first convexly curved partial surface, which is opposite to the upper surface, and a second and a third partial surface, which are opposite one another, are designed as planar surfaces, run at an acute angle relative to one another, the second and the third partial surface being connected to one another via the first partial surface.

In the present context, “convex” is understood to mean “protruding from a plane” or “bulging outward”. The cross-sectional shape of the convex upper side of the cutting insert therefore does not necessarily have to be round, elliptical or semicircular, but can also be angular or have a non-constant course.

The cross-section of the clamping section of the cutting insert is substantially teardrop-shaped according to the above-mentioned refinement. The abutment of the cutting insert with the tool holder takes place via the second and third partial surfaces, which are each designed as planar surfaces. This enables a mechanically stable insert fit within the holder.

In an alternative refinement, the clamping section has a substantially cylindrical cross-section. It is true that the above-mentioned teardrop-shaped cross-section is advantageous from a mechanical point of view with regard to the stability of the insert seat. However, a clamping section with a cylindrical cross-section is much easier to manufacture, especially since the cutting insert, as mentioned above, is made from a bar-shaped raw material.

It shall be understood that the above-mentioned features and those yet to be explained below can be used not only in the combination indicated in each case, but also in other combinations or on their own, without departing from the spirit and scope of the present disclosure.

### BRIEF DESCRIPTION OF THE DRAWINGS

FIG. 1 illustrates a perspective view of an embodiment of the tool;

FIG. 2 illustrates an exploded view of the embodiment of the tool shown in FIG. 1,

FIG. 3 illustrates a longitudinal section of the embodiment of the tool shown in FIG. 1;

FIG. 4 illustrates a cross-section of the embodiment of the tool shown in FIG. 1;

FIG. 5 illustrates a perspective view of a first embodiment of the cutting insert;

FIG. 6 illustrates a detailed view of the cutting insert shown in FIG. 5;

FIG. 7 illustrates a perspective view of a second embodiment of the cutting insert;

FIG. 8 illustrates a detailed view of the cutting insert shown in FIG. 7;

FIG. 9 illustrates a perspective view of a third embodiment of the cutting insert;

and

FIG. 10 illustrates a detailed view of the cutting insert shown in FIG. 9.

### DESCRIPTION OF PREFERRED EMBODIMENTS

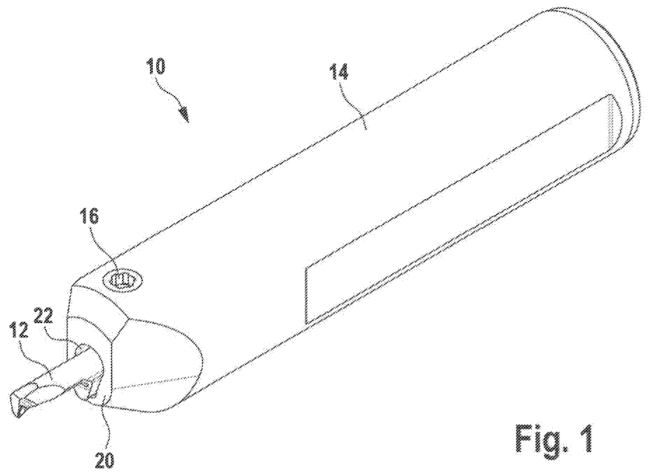

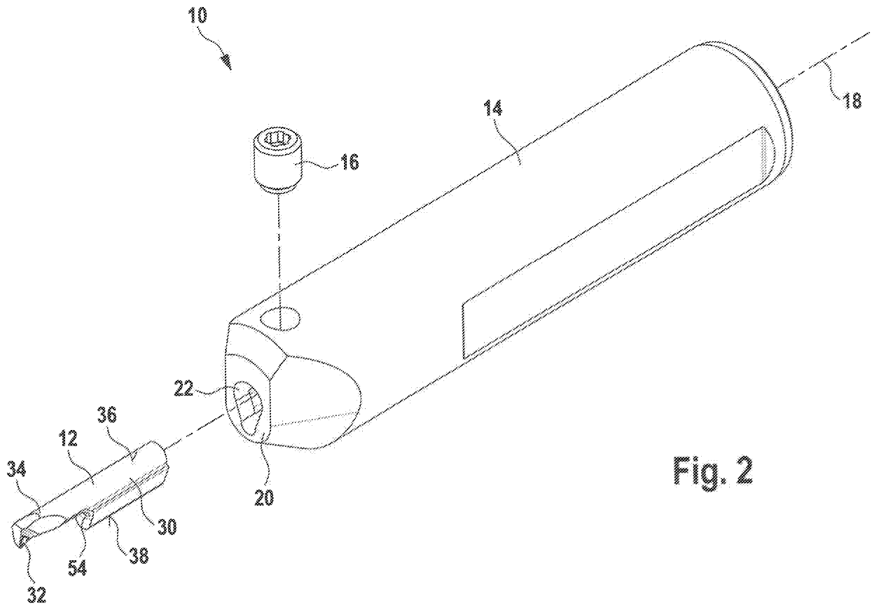

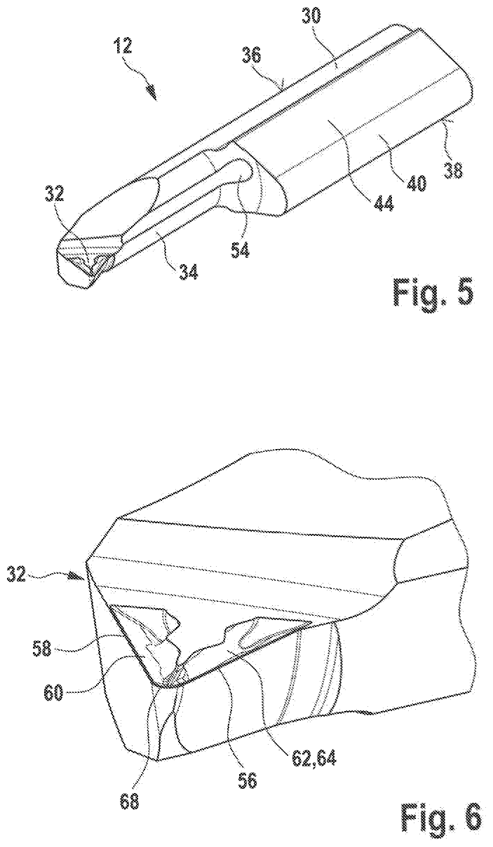

FIGS. 1-4 show an embodiment of the tool in a perspective view, an exploded view, a longitudinal section view and a cross-sectional view. The tool is denoted therein in its entirety with the reference numeral 10. FIGS. 5-10 show three different embodiments of the cutting insert, which can be used in the tool. In each case, the cutting insert is denoted in its entirety with the reference numeral 12.

The tool 10 comprises a cutting insert 12 and a tool holder 14. The cutting insert 12 can be fastened to or in the tool holder 14 by means of a fastening element 16.

The tool holder 14 extends substantially along a holder longitudinal axis 18 and comprises a cutting insert receptacle 22 at a front face end 20. The cutting insert receptacle 22 is introduced into the tool holder 14 in the form of a cup-shaped recess. This cup-shaped recess forms a kind of blind hole in the tool holder 14.

The term “cup-shaped recess” is used herein to clarify that the recess forming the cutting insert receptacle 22 is a cavity in the tool holder 14, which has a closed peripheral wall that is circumferential with respect to the holder longitudinal axis 18 and is open toward the front end face 20 of the tool holder 14. In other words, the cup-shaped recess is formed in the tool holder 14 and is surrounded by the tool holder 14 all around the holder longitudinal axis 18. However, the term “cup-shaped recess” is not intended to be limited to any particular cross-sectional shape. The cross-section of this recess may also have a complex shape. The cup-shaped recess serving as a cutting insert receptacle 22 has a base or inner stop inside the tool holder 14. However, this base or inner stop does not need to be a closed wall. As will be explained further below, for example, one or more bores in the interior of the tool holder 14 can adjoin the cup-shaped recess or the cutting insert receptacle 22.

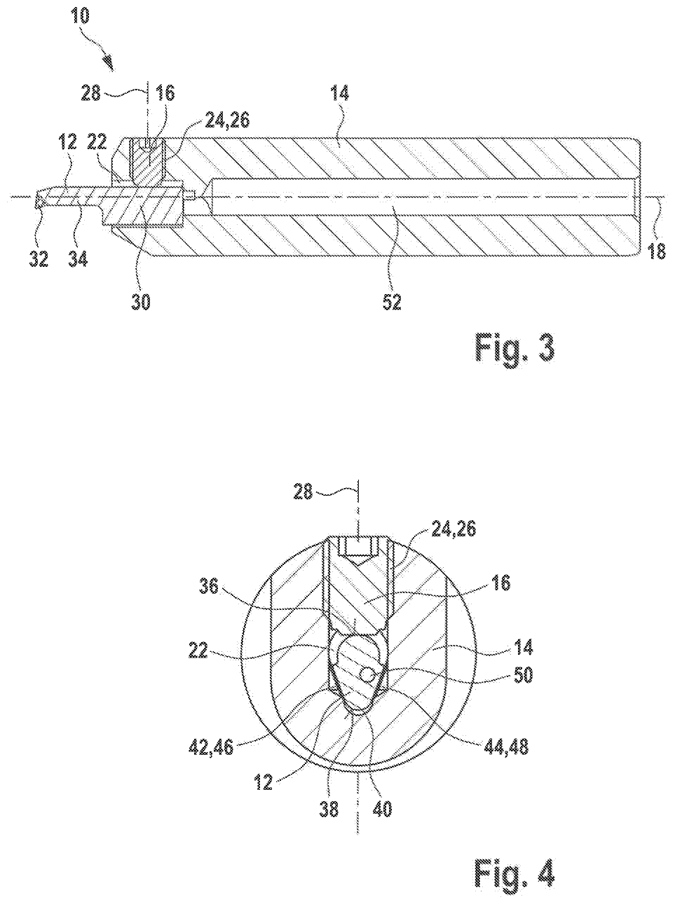

As can be seen in particular from the longitudinal sectional view and cross-sectional view shown in FIGS. 3 and 4, the cutting insert 12 is in the assembled state of the tool at least partially inserted into the cutting insert holder 22 and is fixed to the tool holder 14 by the fastening element 16. The fastening element 16 is configured as a screw in the present case. The screw 16 comprises an external thread which engages in an internal thread 26 arranged in the tool holder 14. The internal thread 26 runs along a thread axis 28 that preferably runs orthogonally to the holder longitudinal axis 18.

In the assembled state, the screw 16 presses the tool 10 preferably from above onto the cutting insert 12, whereby the latter is pressed with its underside into the cutting insert receptacle 22. In the assembled state, the cutting insert 12 contacts the tool holder 14 only with its underside and is contacted on its upper side by the screw 16.

However, in principle it is also possible for the cutting insert 12 to be clamped in the tool holder 14 with the aid of a clamping element, such as this is known from DE 10 2015 104 057 A1.

The cutting insert 12 comprises a clamping section 30, a cutting head 32, and a cantilever arm 34. The cantilever arm 34 connects the cutting head 32 to the clamping section 30. The cutting head 32 is arranged at a first or front end of the cantilever arm 34. The clamping section 30 is arranged at the opposite second or rear end of the cantilever arm 34. The clamping section 30, cantilever arm 34 and cutting head 32 are preferably integrally connected to each other.

In the presently shown embodiment, the clamping section 30 has a substantially teardrop-shaped cross-section (see FIG. 4). The upper surface 36 of the clamping section 30 is convexly curved. The lower surface 38 of the clamping section 30 opposite the upper surface 36 is divided into three partial surfaces 40, 42, 44. The first partial surface 40 is opposite the upper surface 36 and is also convexly curved. The second and third partial surfaces 42, 44 are opposite to each another and are connected to each other by the first partial surface 40. The second and third partial surfaces 42, 44 are each configured as planar surfaces. In the assembled state of the tool 10, the clamping section 30 of the cutting insert 12 preferably does not abut the tool holder 14 with it entire lower surface 38.

The abutment with the tool holder 14 takes place via the two planar surfaces 42, 44, whereas the first partial surface 40 of the clamping section 30 has no direct contact with the tool holder 14. The two partial surfaces 42, 44, which are designed as planar surfaces, rest against corresponding abutment surfaces 46, 48, which are arranged in the interior of the cutting insert receptacle 22. Both the two partial surfaces 42, 44 and the two abutment surfaces 46, 48 each run at an acute angle relative to one another. The abutment surfaces 46, 48 are preferably also designed as planar surfaces. In principle, the partial surfaces 42, 44 can abut the tool holder 14 or the inner walls of the cup-shaped cutting insert receptacle 22 over the entire surface or only linearly, i.e. along a line or straight line.

As further shown in FIG. 4, a cutting insert coolant passage 50 extends through the interior of the cutting insert 12. The cutting insert coolant passage 50 is arranged off-center in the present embodiment. The coolant enters the cutting insert coolant passage 50 through a coolant main passage 52, which extends through the interior of the tool holder 14. The coolant exits the cutting insert coolant passage 50 from a coolant outlet opening 54, which is arranged at a front side of the clamping section 30. The cutting insert coolant passage 50 as well as the coolant outlet opening 54 are thereby aligned in such a way that the resulting coolant jet is preferably directed in the direction of the cutting head 32.

The three embodiments of the cutting insert 12 shown in FIGS. 5-10 differ essentially in the respective shape of the cutting head 32. More specifically, the three embodiments differ in the shape and form of the rake face.

All three embodiments shown in FIGS. 5-10 have in common that the cutting head 32 comprises at least one cutting edge 56. In each of the three embodiments shown here, the cutting head 32 also comprises a second cutting edge 58. In principle, however, the cutting head 32 may comprise only one cutting edge without departing from the spirit and scope of the present disclosure.

A chip surface 60 is adjacent to the at least one cutting edge 56, 58 of the cutting head. All three embodiments shown here also have in common that the rake face 60 comprises a relief-like surface with a chip-breaking geometry 62, which causes chip deflection and thus chip breaking. However, the shape of the relief-like surface or the shape of the chip-breaking geometry 62, respectively, differs from one embodiment to another.

In the first embodiment shown in FIGS. 5 and 6, the chip-breaking geometry 62 is configured as a recessed structure 64 that is introduced into the rake face 60. Here, the recess 64 forming the chip-breaking geometry 62 is recessed or offset downward relative to a cutting plane in which the two cutting edges 56, 58 lie.

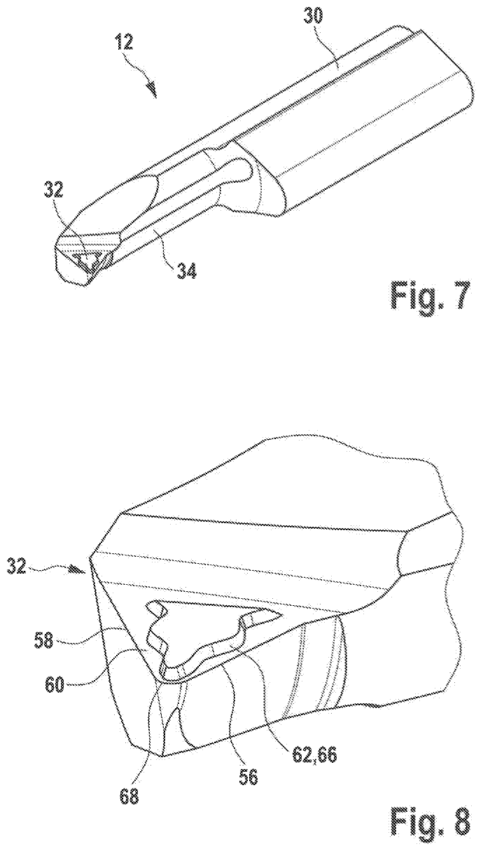

In the second embodiment shown in FIGS. 7 and 8, the chip-breaking geometry 62 is configured as a raised structure 66 that projects upward from the rake face 60. Thus, the chip-breaking geometry 62 is formed here by a raised structure 66. In this case, the raised structure 66 is not directly adjacent to the cutting edges 56, 58. However, as in the first embodiment shown in FIGS. 5 and 6, the chip-breaking geometry 62 also in this case preferably runs along the entire length of each of the two cutting edges 56, 58.

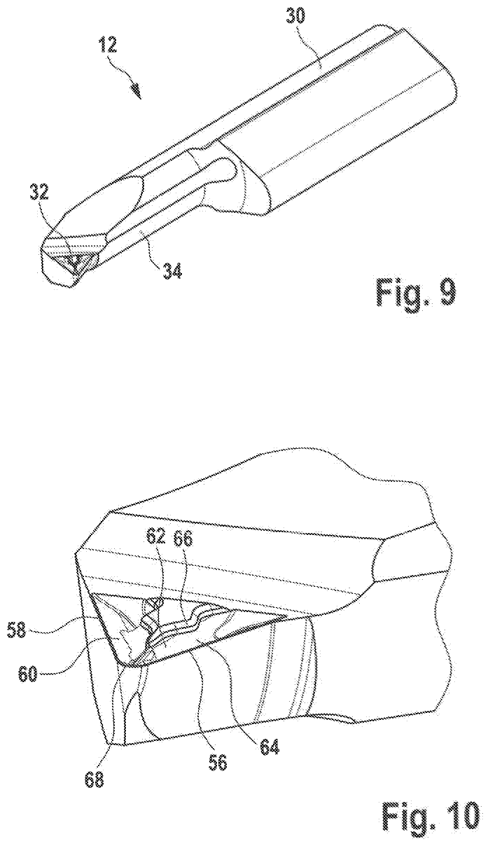

The embodiment shown in FIGS. 9 and 10 is a kind of combination of the first two embodiments. Here, the chip-breaking geometry 62 comprises both a recess 64, which is offset downward relative to the cutting plane, and an elevation 66, which projects upward relative to the cutting plane. The recess 64 is immediately adjacent to the two cutting edges 56, 58. It is arranged between the cutting edges 56, 58 and the elevation 66.

The chip-breaking geometry 62 of all three embodiments is preferably produced by pressing. Preferably, the entire cutting head 32 is produced in a single pressing operation, and only smaller sections, such as the two cutting edges 56, 58, are subsequently machined by grinding.

Alternatively, it is possible to produce the chip-breaking geometry 62 by means of laser machining of the cutting head 32. Such a laser machining, however, only allows the chip-breaking geometry 62 to be produced as a recessed structure 64, such as that shown in FIGS. 5 and 6.

According to all three embodiments, the rake face 60 is preferably mirror-symmetrical with respect to a plane of symmetry which is the same distance from each of the first and second cutting edges 56, 58. The first and the second cutting edges 56, 58 preferably lie in a common cutting plane, as already mentioned. They preferably run at an angle 90° relative to each other. The first and second cutting edges 56, 58 are preferably connected to each other via an arcuate edge 68. This arcuate edge forms the tip of the cutting head 32. The arcuate edge 68 is preferably also arranged in the cutting plane in which the first and second cutting edges 56, 58 lie.

It should be noted, however, that in other embodiments not shown here, the rake face 60 can in principle also be configured asymmetrically. This can make sense in particular because, depending on whether the tool is used in a pressing or a drawing cut, different chip thicknesses result, which may require different geometries.

Finally, it shall be noted that the cutting edges 56, 58 do not necessarily have to be designed as straight cutting edges. In principle, the cutting edges 56, 58 can also be designed as arcuate cutting edges. The shapes of the cutting head shown here serve merely as examples of a variety of possible shapes of the cutting head 32. Just like the cutting edges 56, 58, the shape of the rake face 60 can also vary as desired. The chipbreaking geometry 62, which is preferably designed as a free-form surface, can also vary in shape. However, it is basically designed as a depression and/or elevation so that the rake face 60 has a relief-like surface. The shape of the clamping section 30 likewise does not necessarily have to correspond to the shape shown here. The clamping section 30 can in principle also comprise a cylindrical cross-section.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A cutting insert comprising:
a clamping section having a teardrop-shaped or cylindrical cross-section;
a cutting head; and
a cantilever arm;
wherein the cutting head is arranged at a first end of the cantilever arm and the clamping section is arranged at a second end of the cantilever arm opposite the first end,
wherein the cantilever arm has a smaller cross-section than the clamping section,
wherein the cutting head comprises at least one cutting edge and a rake face adjacent to the at least one cutting edge, and
wherein the rake face comprises a relief-like surface having a chip-breaking geometry that is configured to cause chip deflection and chip breakage.

2. The cutting insert according to claim 1, wherein the chip-breaking geometry is a pressed geometry.

3. The cutting insert according to claim 1, wherein the chip-breaking geometry is a laser cut geometry.

4. The cutting insert according to claim 1, wherein the chip-breaking geometry comprises a raised structure.

5. The cutting insert according to claim 1, wherein the chip-breaking geometry comprises a recessed structure.

6. The cutting insert according to claim 1, wherein a first portion of the chip-breaking geometry comprises a raised structure and a second portion of the chip-breaking geometry comprises a recessed structure.

7. The cutting insert according to claim 1, wherein the at least one cutting edge comprises a first cutting edge and a second cutting edge, wherein the first cutting edge and the second cutting edge lie in a cutting plane, and wherein the chip-breaking geometry is raised and/or recessed relative to the cutting plane.

8. The cutting insert according to claim 1, wherein the chip-breaking geometry extends along an entire length of the at least one cutting edge.

9. The cutting insert according to claim 1, wherein the rake face and the chip-breaking geometry are mirror symmetrical.

10. The cutting insert according to claim 1, wherein the at least one cutting edge comprises a first cutting edge and a second cutting edge, wherein the first cutting edge and the second cutting edge lie in a cutting plane and are oriented at an angle 90° relative to each other.

11. The cutting insert according to claim 10, wherein the first cutting edge and the second cutting edge are connected to each other via an arcuate edge that lies in the cutting plane.

12. The cutting insert according to claim 1, wherein an upper surface of the clamping section is convexly curved and a lower surface of the clamping section comprises a first partial surface, a second partial surface, and a third partial surface, wherein the first partial surface is convexly curved and arranged opposite to the upper surface, wherein the second partial surface and the third partial surface lie opposite to one another, are each designed as planar surfaces, and run at an acute angle relative to one another, and wherein the second partial surface and the third partial surface are connected to one another via the first partial surface.

13. A tool for machining a workpiece, comprising:
a cutting insert having a clamping section, a cutting head, and a cantilever arm,
a tool holder having at a front end a cutting insert receptacle that is configured as a cup-shaped recess in the tool holder and configured to receive the clamping section of the cutting insert; and
a fastening element that is configured to fasten the cutting insert in the cutting insert receptacle;
wherein the cutting head is arranged at a first end of the cantilever arm and the clamping section is arranged at a second end of the cantilever arm opposite the first end,
wherein the cantilever arm has a smaller cross-section than the clamping section,
wherein the cutting head comprises at least one cutting edge and a rake face adjacent to the at least one cutting edge, and
wherein the rake face comprises a relief-like surface having a chip-breaking geometry that is configured to cause chip deflection and chip breakage.
